(19) United States
(12) Patent Application Publication
(10) Pub. No.: US 2012/0158417 A1
(43) Pub. Date: Jun. 21, 2012

(54) Case managed Counter-terrorism System and Process

(76) Inventors: John D. Robusto, California, MD (US); Raymond L. Coutley, Lexington Park, MD (US); Dana A. Paterson, Lexington Park, MD (US); John W. McMaster, Hollywood, MD (US)

(21) Appl. No.: 13/396,089

(22) Filed: Feb. 14, 2012

Related U.S. Application Data
(62) Division of application No. 12/037,642, filed on Feb. 26, 2008.

(51) Int. Cl. G06Q 99/00

(52) U.S. Cl. 705/1.1

(57) ABSTRACT

A machine-implemented Case-Managed ontology and decision support framework provides a basis for a family of machine database architectures for use in a system for countering forces of unknown intentions including fighting and winning the Global War on Terror. The system focuses resource allocation decisions on logically derived, targeted areas of interest with an emphasis on non-kinetic, non-destructive effects. The system combines proven doctrines and novel operational approaches. It employs readily available intelligence information, an ontological understanding of the problem domain, a three-level, metrics-driven, case-managed system and process to counter the forces of unknown origin, and an entire set of operational level activities combining strategic intent, tactical approaches, expected utility analysis, mission-level simulations, and integrated cost modeling.

### GOVERNMENT INTEREST

The invention described herein may be manufactured, licensed, and used by or for the U.S. Government.

### TECHNICAL FIELD

The present invention relates, in general, to a machine implemented system and process for managing complex trans-national problems at strategic, operational, and tactical levels, and more particularly to a case-managed, effects-based system and process for solving problems related to fighting and winning the Global War on Terrorism.

### BACKGROUND

Terrorism is defined in 22 U.S.C. §2656(f) as “premeditated, politically motivated violence perpetrated against noncombatant targets by subnational groups or clandestine agents.” It takes the form of violent acts and/or threats of violence, which are calculated to instill fear in a population and to advance political goals. Terrorist enemies confronting the United States and its partners today include transnational movements of extremist organizations, networks, individuals, and their state and non-state supporters.

In the wake of the 9/11 attacks, the United States and its partners have been engaged in a concerted effort to combat terrorism known as the Global War on Terrorism (GWOT). The GWOT is a constantly evolving battle involving both arms and ideas. While the GWOT has succeeded on many levels and security has been significantly increased, a great deal more needs be done to anticipate and effectively counter the actions of terror organizations. What is needed is a problem solving approach based on a model that takes into account a broad range of relevant geopolitical factors in order to develop strategies, operations, and tactics that are tailored to disrupt, deny, and interfere with terrorist organizations and at the same time respect international agreements, sovereignty and freedom in the community of nations. Embodiments according to the present invention address these concerns by providing a case-managed counter terrorism system and process that provides:
A multi-user collaborative counter-terrorism planning and analysis environment,
support for government-wide, inter-agency coordination and,
a systematic, effects-based approach to fighting and winning the Global War on Terrorism that focuses resources on logically derived, targeted areas of interest with an emphasis on non-kinetic, non-destructive effects.

### SUMMARY

In general, in one aspect, a computer program product that is embodied in a computer-readable medium, for countering forces of unknown intentions on a global scale, including terrorism, provides an ontology and decision support framework that forms a basis for a family of database architectures to enable workflow, decision making, and collaboration between strategic, operational, and tactical components of a campaign. The computer program product is configured to store program instructions for execution on a computer system enabling the computer system to perform instructions which include a strategic case that is defined within a strategic case owner's geographical area of responsibility, an operational case to address a strategic objective according to strategic and operational metrics, and which defines a named area of interest in which to identify a conspiracy within the strategic case owner's geographical area of responsibility, and a tactical case to address an operational objective of the operational case according to an operational metric, and in which the workflow of the campaign follows a case management approach.

In general, in another aspect, a computer program product embodied in a computer-readable medium, that provides a case managed system, includes software instructions for enabling the computer to perform predetermined operations, and a machine-readable medium bearing the software instructions. The predetermined operations include developing a hierarchy of metrics at tactical, operational and strategic levels to determine the degree of success achieved at each level, determining centers of power for a named area of interest where a conspiracy exists, gathering open source information and intelligence to identify transactions between a plurality of centers of power in the named area of interest, determining targeted areas of interest from the identified transactions between the plurality of centers of power in the named area of interest, collecting information within each targeted area of interest to develop a systematic understanding of the conspiracy, creating a campaign plan to identify one or more optimum courses of action to disrupt the terrorist conspiracy, executing the campaign plan based on a front end assessment of the likely reaction of the terrorist conspiracy to the one or more courses of action; and reassessing and revising the campaign plan, as necessary, during execution until the tactical, operational and strategic metrics have achieved the predetermined levels of success.

### BRIEF DESCRIPTION OF DRAWINGS

FIG. 1 shows a Unified Modeling Language (UML) Ontology used by the Case Managed Counter-Terrorism System and Process (CMCTS) in accordance with the present invention.

FIG. 1A is a more detailed view of a portion of FIG. 1 on the left side delineated by dashed lines and labeled “SEE FIG. 1A.”

FIG. 1B is a more detailed view of a portion of FIG. 1 on the right side delineated by dashed lines and labeled “SEE FIG. 1B.”

FIG. 2 shows the overall workflow and activities of the CMCTS in accordance with the present invention.

FIG. 2A is a more detailed view of a top portion of FIG. 2 delineated by dashed lines and labeled “SEE FIG. 2A.”

FIG. 2B is a more detailed view of a middle portion of FIG. 2 delineated by dashed lines and labeled “SEE FIG. 2B.”

FIG. 2C is a more detailed view of a bottom portion of FIG. 2 delineated by dashed lines and labeled “SEE FIG. 2C.”

FIG. 3 shows a diagram of the workflows and activities associated with Front End Assessment in accordance with the present invention.

FIG. 3A is a more detailed view of a top portion of FIG. 3 delineated by dashed lines and labeled “SEE FIG. 3A.”

FIG. 3B is a more detailed view of a middle portion of FIG. 3 delineated by dashed lines and labeled “SEE FIG. 3B.”

FIG. 3C is a more detailed view of a bottom portion of FIG. 3 delineated by dashed lines and labeled “SEE FIG. 2C.”

FIG. 4 shows a graphical representation of a Course of Action Taxonomy according to one aspect of the present invention.

FIG. 5 shows a graphical representation of a Centers of Power (COP) view of an exemplary terrorist conspiracy according to one aspect of the present invention.

FIG. 6 shows a graphical representation of a campaign planning activity according to one aspect of the present invention.

FIG. 7 shows a block diagram of an exemplary implementation of a CMCTS in accordance with one aspect of the present invention.

FIG. 8 shows a graphical representation of a CMCTS Expected Utility Analysis according to one aspect of the present invention.

FIG. 8A is a more detailed view of a portion of FIG. 8 on the left side delineated by dashed lines and labeled “SEE FIG. 8A.”

FIG. 8B is a more detailed view of a portion of FIG. 8 on the right side delineated by dashed lines and labeled “SEE FIG. 8B.”

FIG. 9 shows a graphical representation of the CMCTS Collection Activities in accordance with the present invention.

### DETAILED DESCRIPTION

In the following detailed description, reference is made to the accompanying drawings. The drawings are a part of this disclosure and illustrate specific embodiments in which the invention, as claimed, may be practiced. The invention, however, may be embodied in many different forms and should not be construed as limited to the embodiments set forth; rather, these embodiments are provided so that this disclosure will be thorough and complete, and will fully convey the scope of the invention to those skilled in the art. As will be appreciated by those of skill in the art, the present invention may be embodied in methods, systems and apparatus. Wherever possible, the same reference numbers will be used throughout the drawings to refer to the same or like components or parts.

While this patent document employs military doctrine and terminology to describe some aspects of the invention, the present invention extends considerably beyond conventional military responses to terrorism by providing a multi-disciplinary, effects-based solution that incorporates both military and non-military capabilities and strategies. Thus, the term “target” as used herein includes, among other things, non-physical financial entities. For example, a bank account or a set of banking documents may be a potential counter-terrorism target. Likewise, the terms “Named Areas of Interest,” “Targeted Areas of Interest,” “Centers of Gravity” and “Decisive Points” are identified just as in classical military campaign planning, but also include a standard set of social, political, and economic attributes in addition to the geophysical and industrial attributes that military planners have long applied to classical military targets.

Embodiments of a CMCTS according to the present invention are designed to bridge the gap between strategic intent and tactical action. The CMCTS provides a repeatable and generalize-able process for managing massive-scale complex problems with vast geographic and geopolitical implications related to the Global War on Terror (GWOT). Embodiments of a CMCTS according to the present invention are designed to provide a systematic, effects-based approach that is able to sustain operational tempos calculated to overwhelm an adversary's decision-making and resource allocation processes. CMCTS embodiments also provide a framework and process for focusing U.S. and Allied resource allocation decisions on logically derived, targeted areas of interest with an emphasis on non-kinetic non-destructive effects. The process systematically applies a host of tools built around a combination of proven doctrines and novel operational approaches. These general methods are focused by available intelligence information, an ontological understanding of the problem domain, and a metrics-based management methodology. Embodiments of the CMCTS can be applied anywhere and everywhere terrorists live and operate. While illustrative embodiments concern terrorism, alternative embodiments of a CMCTS according to the present invention may be employed in other global or national domains to disrupt or counter drug trafficking, child slavery, piracy and raiding of merchant traffic, black market or grey market trafficking as well as other underground or organized criminal ventures.

Embodiments of a CMCTS are modeled on case management systems and techniques that have been drawn from fields including medicine, legal advocacy, and law enforcement. While expertise involved in the practices of medicine and law and in the law enforcement professions are different from one another; each field shares a concern with countering forces of unknown intentions and each must be discovered, characterized, understood and defeated in order to succeed. Some of the ways in which these fields apply similar case-managed approaches to achieve objectives, include:
using a combination of fortuitous and deliberate information acquisition;
having a document management system that can create and maintain an unpredictable numbers of relevant documents;
having the ability to respond to surprise, sporadic, asynchronous, time-critical actions and surges in action;
being able to develop opponent-specific defeat mechanisms,
having the ability to coordinate human activity and to distribute and redirect workflow, and
having the ability to respond to asynchronous timing issues arising from external sources.

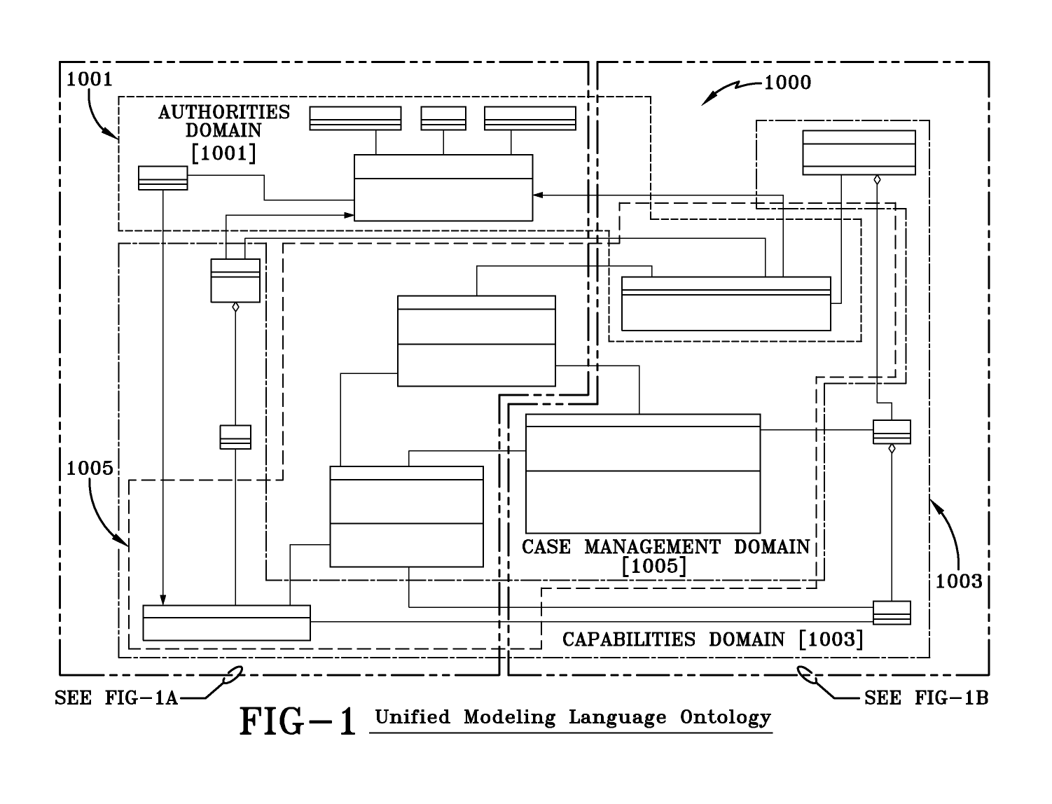

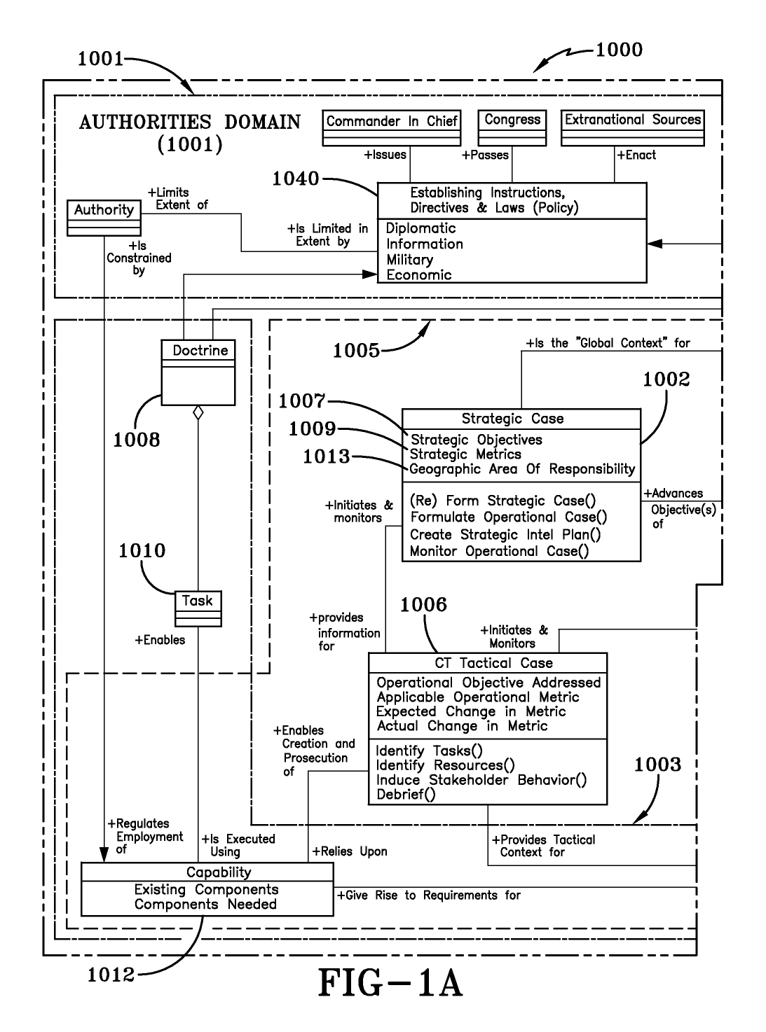

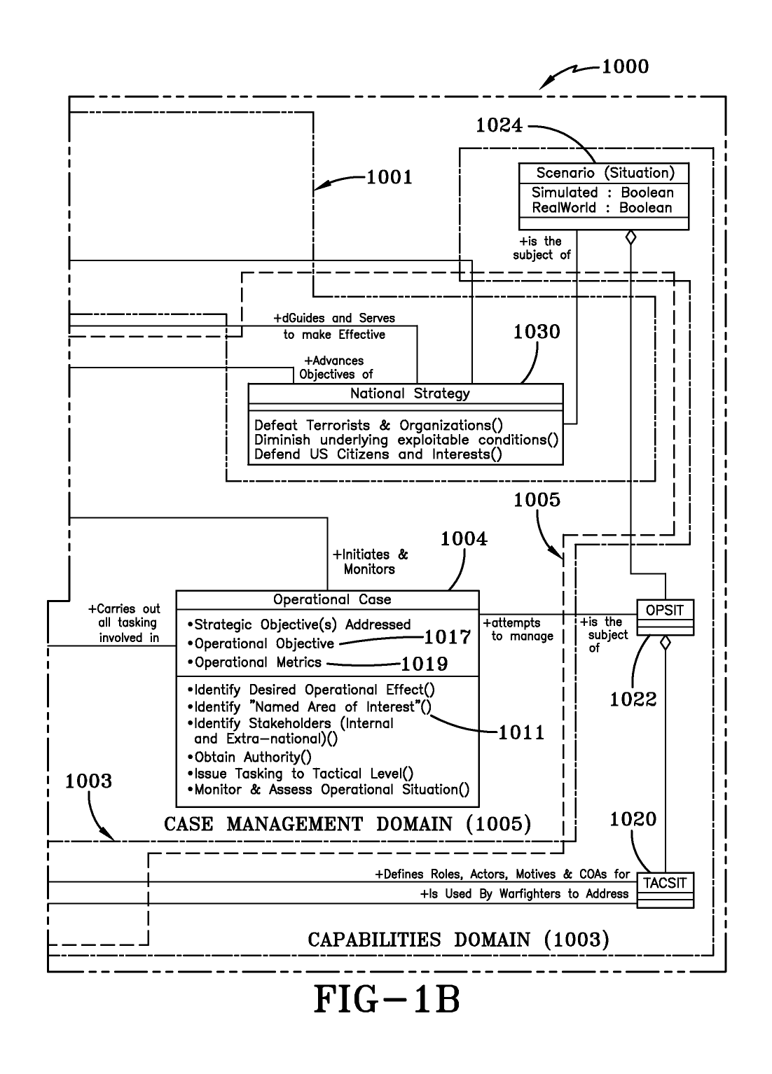

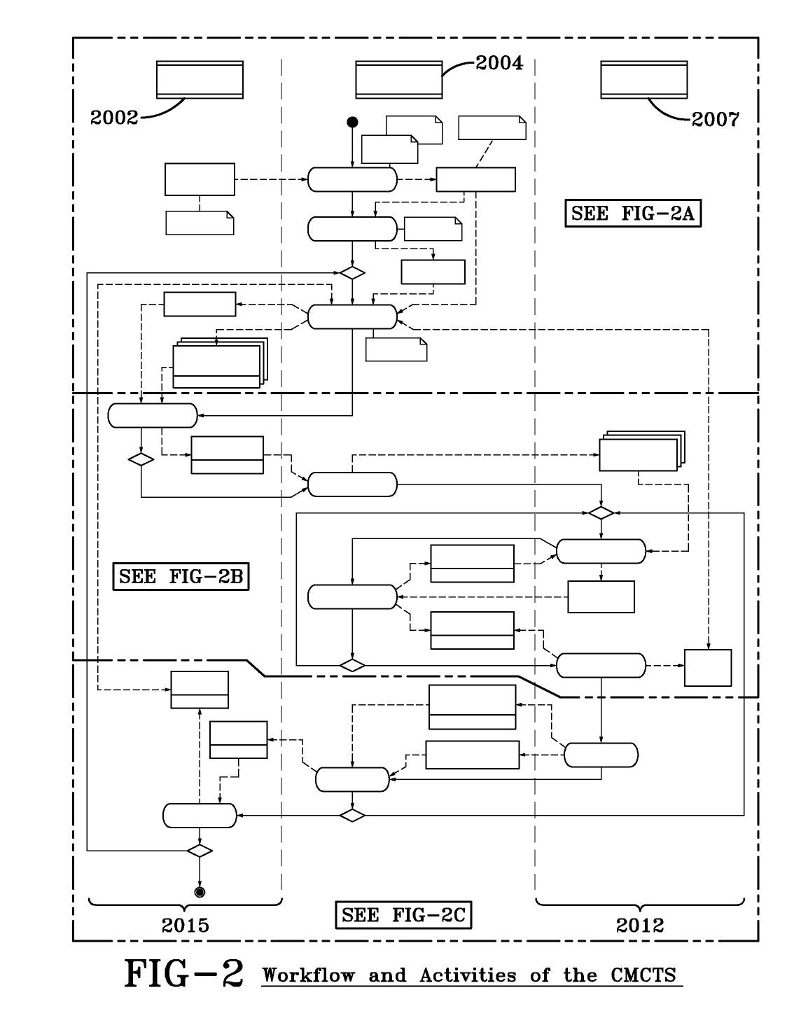

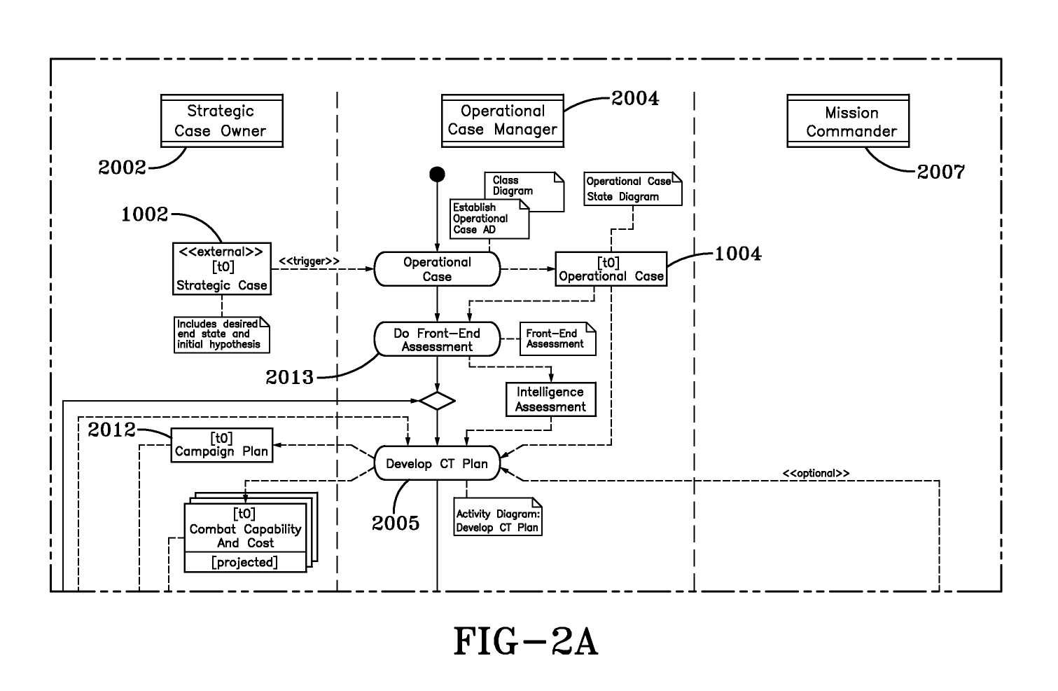

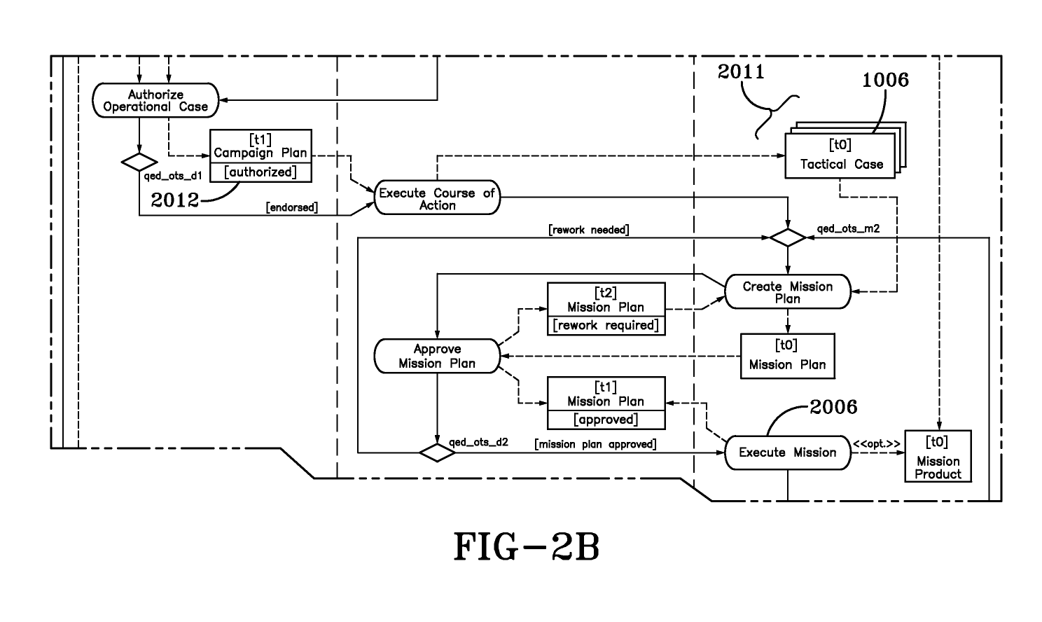

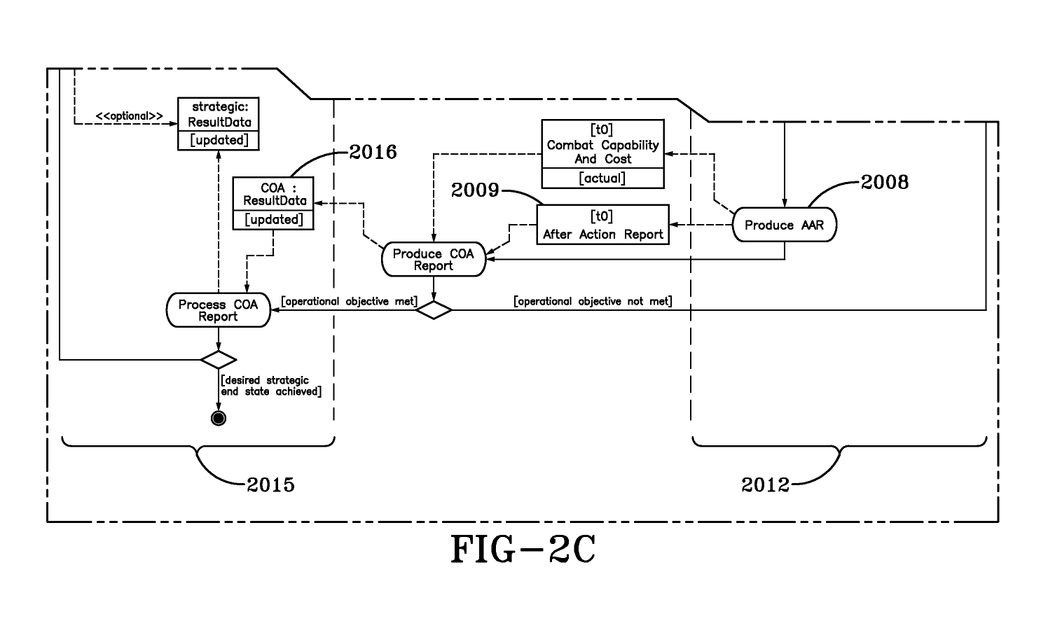

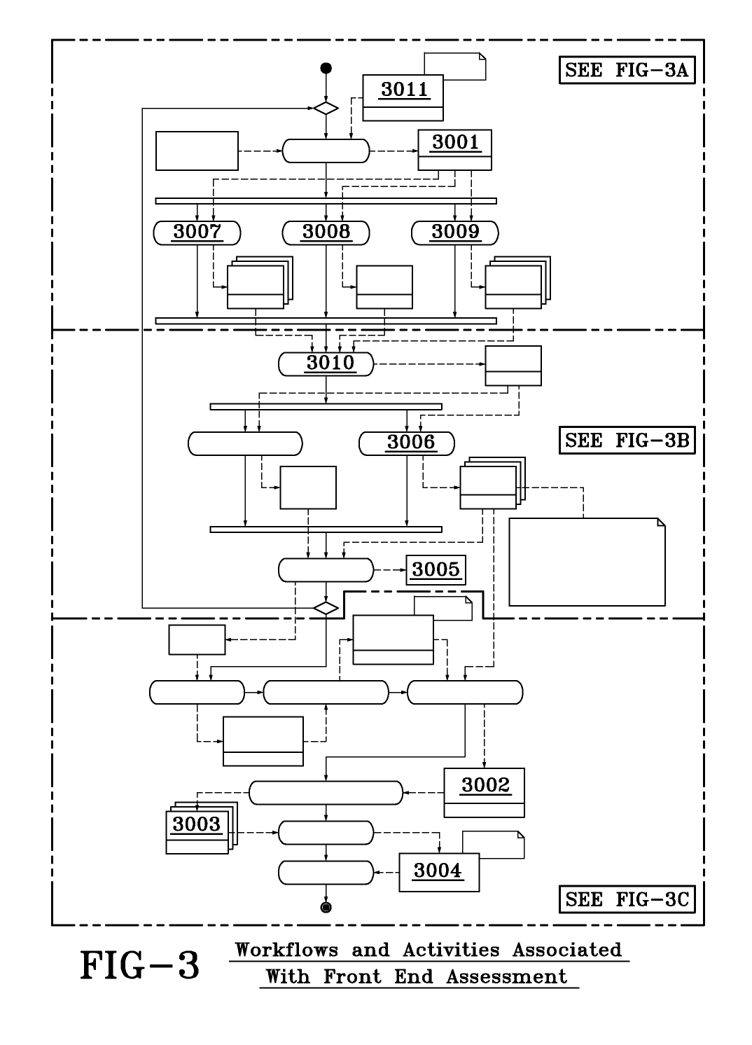

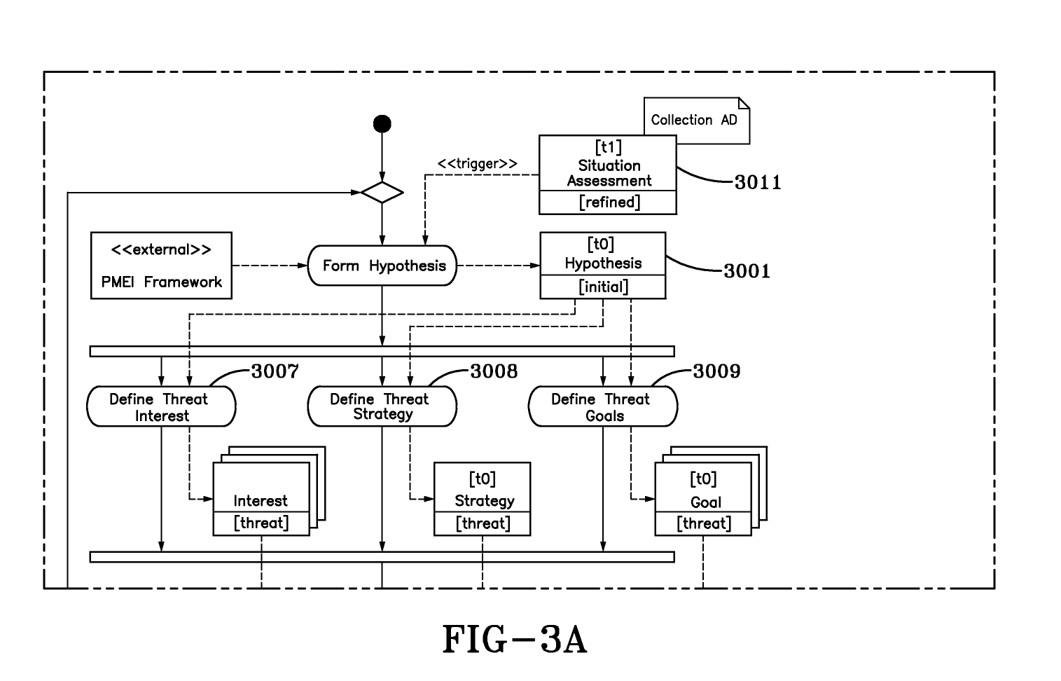

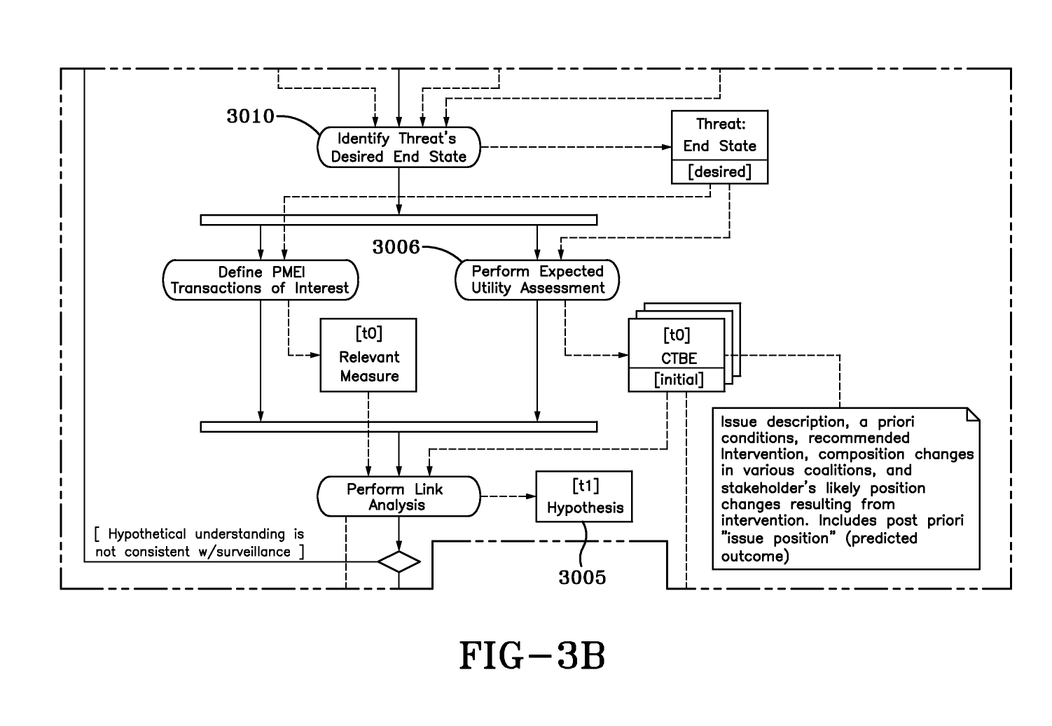

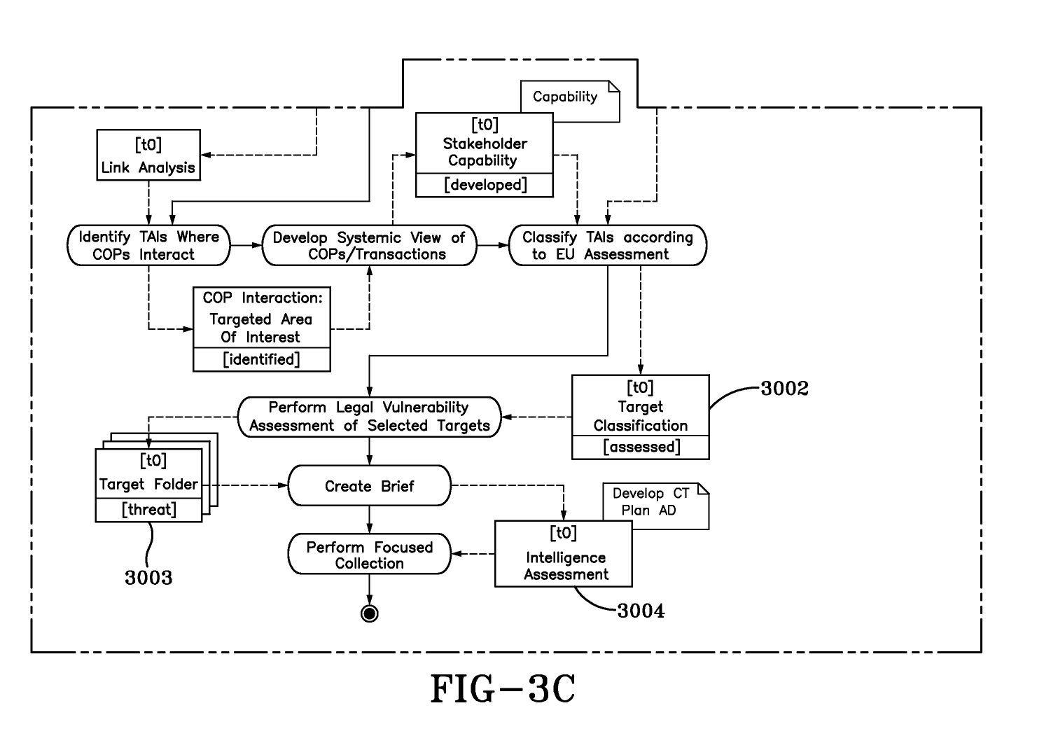

FIG. 1, and the more detailed views of the block diagram of FIG. 1 shown FIGS. 1A and 1B, show a Unified Modeling language (UML) representation of an ontology 1000 according to an embodiment of the present invention. Ontology 1000 provides an explicit, systematic specification for the concepts used in the CMCTS, enabling collaboration and decision making between strategic, operational, and tactical components of a global counterterrorism strategy. Ontology 1000 essentially provides a hierarchical case-structured multi-tiered framework that specifies work products, plans, information, and authorizations required to carry out a CMCTS process at each level. Ontology 1000 is divided into three basic domains, an Authorities Domain 1001, a Capabilities Domain 1003 and a Case Management Domain 1005. For purposes of this disclosure, a “domain” includes spheres of activity, concerns, and functions. While Ontology 1000 is a representative example of a CMCTS according to the present invention alternative embodiments may be based on ontologies that differ from the example, without departing from the spirit of the invention. For example, while UML has been used to construct Ontology 1000, other representational tools may be employed. FIG. 2 and the more detailed views of the block diagram of FIG. 2 shown FIGS. 2A, 2B and 2C, provide a graphical representation of the overall CMCTS process flow. FIG. 3 and the more detailed views of the block diagram of FIG. 3 shown FIGS. 3A, 3B and 3C, illustrate flows of the Front End Assessment portion of CTCMS process. These diagrams, in conjunction with the Ontology 1000, outline the CTCMS at a high level and will be referred to in detail in the following description.

### Authorities Domain

Authorities Domain 1001 encompasses authorities derived from policies, directives and laws (generated by the President of the United States, Congress, and by international agreement) which, in the national interest (and in response to real world scenarios), provide strategic guidance that motivates specific actions. Authorities Domain 1001 develops a national strategy 1030 that creates an impetus for counter-terrorism and also regulates and places limits on the employment of capabilities.

### Capabilities Domain

Capabilities Domain 1003 encompasses one or more Capability 1012. A “capability,” as the term is used herein, is a temporary aggregation of people, equipment, tactics, techniques or procedures brought together to address a class of Tactical Situations 1020. Capability 1012 may include military or non-military assets, or a combination of both. For example, four SH-60R Strikehawk helicopters, and a Surface Action Group networked internally and externally to various worldwide intelligence systems might form a potent maritime intelligence, surveillance, and reconnaissance (ISR) capability if they are tasked to do so, equipped with proper sensors and if their crews are properly trained. This capability might be brought together to address a host of Tactical Situations 1020 requiring intelligence, surveillance and reconnaissance of maritime areas of interest. Of course, these same assets may be aggregated differently and at different times into completely different capabilities. The notion of capability 1012 also includes so-called multi-mission systems that simultaneously support multiple capabilities. The Global Positioning System is a prime example.

In Capabilities Domain 1003, a Doctrine 1008, which is a statement of official government policy, especially concerning foreign affairs and military strategy, provides the taxonomy or basis for classifying Tasks 1010 that Capability 1012 will make possible. Capabilities 1012 are brought to bear in Tactical Situations (TACSITs) 1020 and Operational Situations (OPSITs) 1022 in light of Scenarios 1024, which may include real world and simulated situations.

### Case Management Domain

Case Management Domain 1005 is made up of Strategic Cases 1002, Operational Cases 1004, and Tactical Cases 1006. A Strategic Case 1002 includes a set of Strategic Objectives 1007 that form the source of counterterrorism Operational Objectives 1017 for an Operational Case 1004. An Operational Case 1004 is aimed at making progress toward the achievement of one or more Strategic Objectives 1007, using non-military and indigenous tactical assets wherever possible. Tactical Cases 1006 address Operational Objectives 1017.

A National Strategy for combating terrorism 1030 developed according to Ontology 1000 is designed to advance global counterterrorism goals based upon Strategic Cases 1002 pursued by Strategic Case Owners 2002 (SCO) in each of their respective Geographic Areas of Responsibility 1013. These Geographic Areas of Responsibility 1013 may include one or more independent nation-states, dependencies, areas of special sovereignty or a collection of contiguous nation-states. Independent nation-states, dependencies and areas of special sovereignty are defined in accordance with the U.S. Department of State. In this embodiment, Bureau of Intelligence and Research of the U.S. Department of State definitions have been employed. The Geographic Area of Responsibility 1013 sets the context and determines the relevant authorities, availability of capabilities and resources for Named Areas of Interest (NAIs) 1011 in Operational Cases 1004.

### Strategic Cases

While each Strategic Case 1002 is geographically defined, certain overarching Strategic Objectives 1007 are common to all. In accordance with current National Strategy 1030, Strategic Objectives 1007 are presently aimed at defeating terrorists and terrorist organizations, diminishing underlying conditions that may be exploited by terrorists and defending U.S. and coalition citizens and interests. Each Strategic Case 1002 receives its impetus from and is guided by Strategic Objectives 1007 drawn from National Strategy 1030, which is derived at the highest levels from policies, instructions, directives, laws and agreements from sources including the U.S. Commander-in-Chief, the U.S. Congress as well as from extra-national authorities in states that are aligned with the U.S. 1040. Strategic Metrics 1009 are defined for each Strategic Objective 1007.

In each Geographic Area of Responsibility 1013 SCO 2002 is the lead authority that represents the counter-terrorism interests of the United States and its allies. In some Geographic Areas of Responsibility 1013, SCO 2002 may be a Department of State official. In others, SCO 2002 may be a high ranking military officer or Unified Commander. In general, SCO 2002 monitors and reports terrorism incidents in Geographic Area of Responsibility 1013 up through his or her chain of command to a command authority. In the case of a Department of State official SCO 2002, for example, the command authority is the Ambassador At Large (Counter-Terrorism Coordinator). For a military officer SCO 2002, the command authority Originates with the Executive Branch of the United States Government and is delegated, downward to the appropriate level.

SCO 2002 establishes Strategic Objectives 1007 and Strategic Metrics 1009 for Geographic Area of Responsibility 1013. Strategic Metrics 1009 are defined in quantitatively calculable terms and form the basis for counter-terrorism status reports to leaders in the U.S. Executive and Legislative Branches and extra-national authorities, where appropriate. SCO 2002 is responsible for authorizing and providing the requisite level of endorsement for Campaign Plans and activities suggested by the counter-terrorism Operational Case Manager (OCM) 2004.

### Operational Cases

Operational cases 1004 address one or more Strategic Objectives 1007. The scope of an Operational Case 1004 generally covers one or more tactical case 1006. An OCM 2004 is placed in charge of an Operational Case 1004 and may be rotated into place specifically to handle an Operational Case 1004. Before an Operational Case 1004 is opened, OCM 2004 determines which Strategic Objectives 1007 the Operational Case 1004 will address, evaluates the relative importance of each, and determines how much of a change in each Strategic Metric 1009 should result. OCM 2004 also estimates the anticipated closing data of Operational Case 1004 and the budget and resources required. The activities of OCM 2004 are identified in the OCM swimlane 2015 on the left side of the Activity Diagram in FIG. 2. There may be multiple implementations of Operational Cases 1004 under a single Strategic Case 1002 each having its own OCM 2004, Operational Objectives 1017 and Operational Metrics 1019.

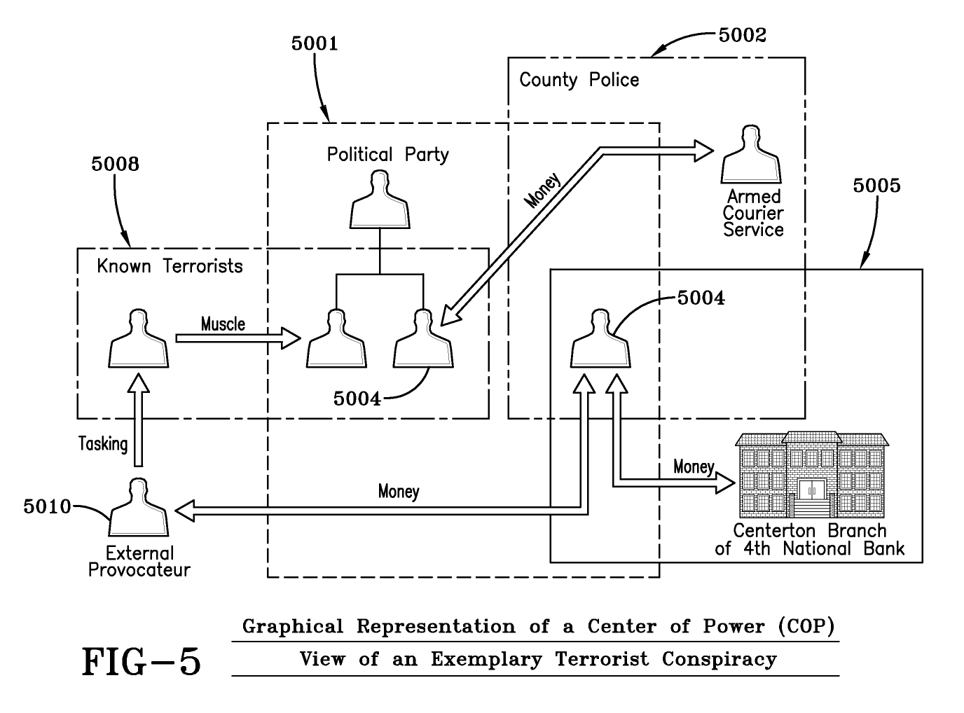

When SCO 2002 approves an Operational Case 1004, OCM 2004 will perform a Front End Assessment 2013 and ultimately formulate a Counterterrorism Campaign Plan 2012 or a series of Counterterrorism Campaign Plans 2021. The CT Campaign Plan 2012 identifies and outlines Operational Objectives 1017 that correspond to one or more Strategic Objectives 1007. Operational Objectives 1017 are significant milestones along the way to achieving some portion of the expected shift in a Strategic Metric 1009. Each Operational Objective 1017 also has quantifiably calculable Operational Metrics 1019 that can be aggregated mathematically to determine their strategic effect. Operational Metrics 1019 form the basis for counter-terrorism status reports to SCO 2002. Operational Metrics 1019 are aimed at measuring factors such as the reductions in size of participant organizations and extent of interconnections between participant organizations or individuals suspected of involvement in the terrorist conspiracy as shown in FIG. 5 Centers of Power View 5000, discussed more particularly below.

An Operational Case 1004 requires resources to address Strategic Objectives 1007 of Strategic Case 1002. The resources needed in an Operational Case 1004 are estimated by the OCM 2004 using knowledge and information gathered in NAI 1011 in view of Operational Objectives 1017.

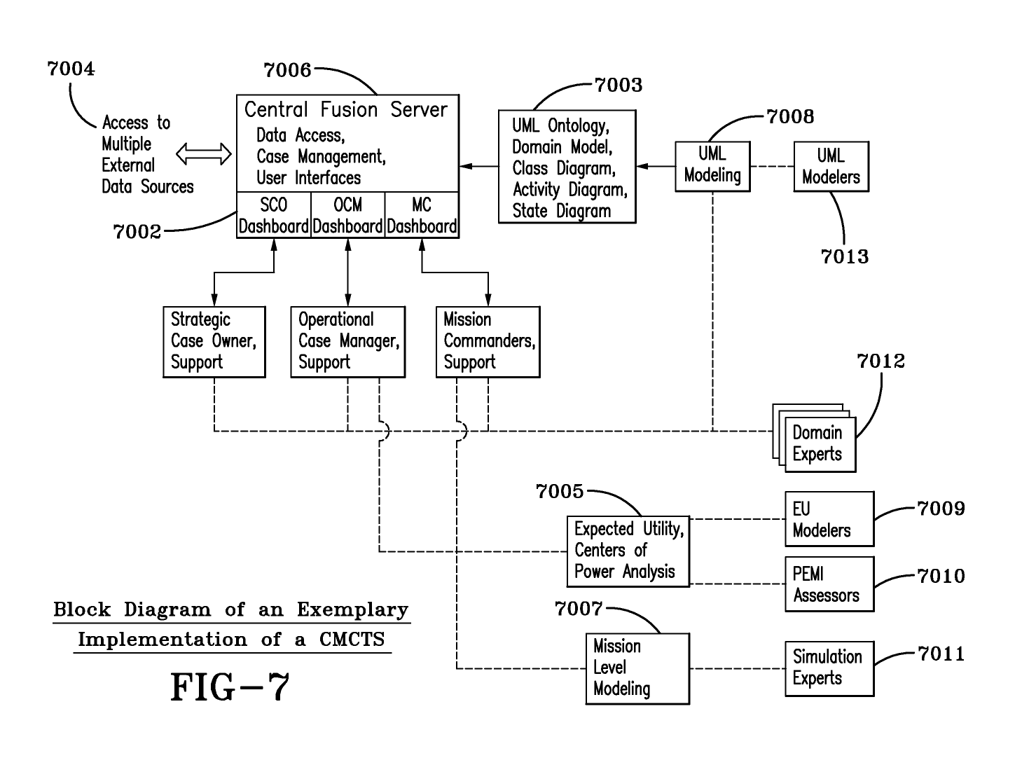

The OCM 2004 can employ mission-level Simulations/Modeling 7007 (FIG. 7) to evaluate candidate interventions for the developing Campaign Plan 2012. Simulations/Modeling 7007 are integrated with extensive cost modeling, covering acquisition, fielding, support cost, operating cost, training cost and other life cycle costs, to enable simultaneous cost-of-capability assessment. While multiple Simulations/Modeling exist, the framework of the CTCMS can be made to operate with virtually any of them, provided the full range of lifecycle costs are accounted for. In this way, each simulated alternative intervention, and the entire Campaign Plan 2012 can be evaluated in terms of relative cost. The consideration of cost in parallel with Operational Metrics 1019 and Strategic Metrics 1009 allows for a very efficient application of resources. Innovative technologies, early development products and new techniques and procedures can also be evaluated for potential inclusion in a Campaign Plan 2012, using Simulations 7007. Integrated with the cost models, this allows the assessment of cost-of-capability for specific objectives at early phases of development, further reducing expenditure of resources on less effective approaches.

A comprehensive, multi-disciplinary Counter-Terrorism Campaign Plan 2012 places indigenous law enforcement, international financial entities, along with indigenous and international military tactical assets at the disposal of an OCM 2004 and will frequently require that SCO 2002 and OCM 2004 work together with international authorities in a NAI 1011. An Operational Case 1004 favors approaches to targeting and campaign planning that are not specifically designed to kill or capture terrorists. Rather, the goal of an OCM 2004 is to identify and disrupt conspiracies that employ terrorism as a means to achieve political or ideological change. Simply put, an embodiment of a Campaign Plan 2012 has as its primary goal the disruption of terrorism. Such disruption may be caused by employing properly paced, low-profile tactical actions designed with a clear understanding of a particular terrorist's strategy, means, and desired political ends. These actions place a high value on low-profile effectiveness and seek to avoid the generation of broadly published success stories.

### Tactical Cases

Tactical Cases 1006 contain estimates by Operational Metrics 1019 of the contributions that successfully executed Missions 2006 will make toward achieving one or more Operational Objectives 1017. Conversely, estimates of the negative effects of failure are assigned to each Mission 2006. A Tactical Case 1006 may be confined to a single Mission 2006. Frequently, however, a Tactical Case 1006 will include several Missions 2006 that are designed to cover a complete Course of Action 2011 in achieving an Operational Objective 1017.

Each Mission 2006 is designed to advance Operational Metrics 1019 for an Operational Objective 1017. It is the Mission Commander's responsibility to estimate the effects of each mission upon Operational Metrics 1019 during the development of the Mission Plan 2005. Following execution of a Mission 2006, a Mission Commander 2007 and an analyst who reports to the Operation Case Manager 2004 will conduct an after action review 2008 to determine whether or not, and the extent to which, the success or failure of Mission Execution 2006 contributes to a positive or negative shift in one or more Operational Metric 1019. They will then report these findings to the Operational Case Manager in an After Action Report 2009. The range of a Mission Commander's activities are bounded by the right-hand swimlane 2010 in the Activity Diagram of FIG. 2.

In some instances, a Tactical Case 1006 may be an information gathering mission for a Strategic Case 1002, in others a Tactical Case 1006 will be part of a Courses of Action 2011 that advances one or more Operational Objectives 1017. Tactical Cases 1006 may also be used to determine changes that may be expected to be achieved in operational and strategic metrics and to record actual changes in metrics. Tactical Cases 1006 may further identify tasks and resources needed to carry out Operational Objectives 1017 and seek to induce stakeholder behavior to advance those objectives. Debriefing may also generally be undertaken in Tactical Cases 1006.

### Courses of Action

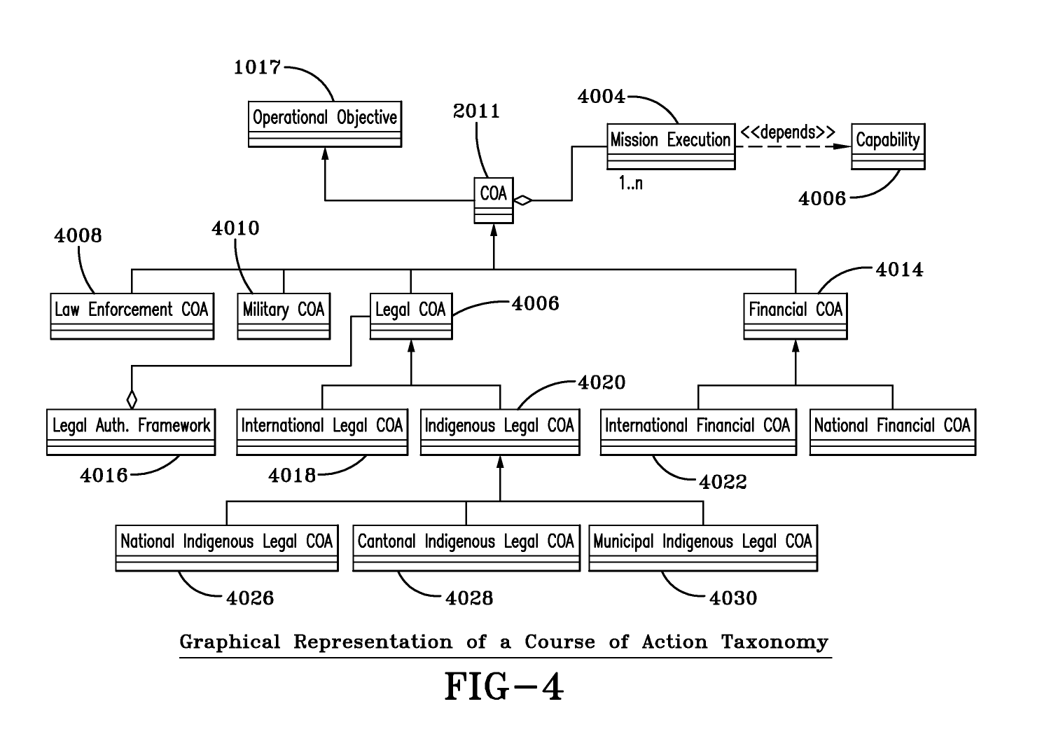

As shown in FIG. 2, and the expansion of FIG. 2 in FIGS. 2A, 2B and 2C, a Course of Action 2011 may be viewed as an aggregation of Tactical Cases 1006 and Missions 2006, executed serially or concurrently, and which are designed to achieve a particular Operational Objective 1017 identified in Campaign Plan 2012. FIG. 4 shows a representative Course of Action 2011 taxonomy in the context of an embodiment of a CMCTS. One aspect of Course of Action 2011 includes assessment of Legal Advocacy Courses of Action 4012, such as advocating changes in laws or regulations to achieve an Operational Objective 1017. Assessment of a Legal Advocacy Course of Action 4012 includes determining a Legal Authority Framework 4016, International Legal Courses of Action 4018 and Indigenous Legal Courses of Action 4020. Indigenous Legal Courses of Action 4020 may include assessment of National Indigenous Legal Courses of Action 4026, Cantonal Indigenous Legal Courses of Action 4028 and Municipal Indigenous Legal Courses of Action 4030. Another aspect of a Course of Action 2011 includes assessment of Military Courses of Action 4010 and Law Enforcement Courses of Action 4008.

### CMCTS Activities

FIG. 2, and the expansion of FIG. 2 in FIGS. 2A, 2B and 2C, provide an overview of the activities of an embodiment of a CMCTS according to the present invention. A Strategic Case 1002 is initiated by an SCO 2002 when it is determined (through the use of the SCO's own information gathering and analysis processes) that terrorism is occurring in the SCO's geographic area of responsibility 1013. Then, SCO 2002 performs activities which include assignment of an OCM 2004, provision of the SCO's Strategic Case 1002 to OCM 2004 which includes the SCO's Initial Hypothesis 3001 about the nature and extent of the suspected terrorist conspiracy, and finally, charging the OCM 2004 to create an Operational Case 1004. At this point Operational Case 1004 is considered to be “open” and Intelligence Collection Activity 9000 begins. Intelligence Collection Activity 9000 continues until the Operational Case 1004 is officially closed. Once the Operational Case 1004 is opened, the SCO's Initial Hypothesis 3001 and intelligence from Intelligence Collection Activity 9000 are used to support a Front End Assessment process 2013. In Front End Assessment 2013, analysts use existing information, their understanding of power arbitrage and a Centers of Power Analysis 5000 to identify candidate Targeted Areas of Interest 5004. This results in a Target Classification List 3002 in which targets are classified by their criticality to the conspiracy. Target Folders 3003 for each target outline each target's vulnerabilities to various Courses of Action 2011. The Target Classification List 3002 and Target Folder 3003 are produced by intelligence analysts who further process them to produce an Intelligence Assessment 3004 for the Named Area of Interest 1011. Intelligence Assessments 3004 are refined until a Supported Hypothesis 3005 that refutes, proves, or corrects the SCO's Initial Hypothesis 3001 is created. Front End Assessment ends when the OCM 2004 articulates a clear and corroborated terrorist conspiracy to SCO 2002 and SCO 2002 decides whether OCM 2004 will be allowed to go forward with a Campaign Plan 2012 to disrupt the conspiracy or whether the Operational Case 1004 should, instead, be closed.

Development of Campaign Plan 2012 is carried out by the OCM 2004 and involves identification, characterization and evaluation of individuals and organizations whose collaborations (i.e., Targeted Areas of Interest 5004) embodies the terrorist conspiracy in the Named Area of Interest 1011. Once the Targeted Areas of Interest 5004 have been fully characterized and the resources, willingness to act, and positions taken within the Targeted Area of Interest are documented; several alternative Courses of Action 2011 are proposed. Expected Utility Analysis 6006 is conducted on the conspiracy stakeholders and the U.S./Allied/Indigenous stakeholders. Expected Utility Analysis 6006 yields a predicted new state of affairs subsequent to each proposed Course of Action 2011. Simulations 6008 of entire sets of options are performed. These simulations 6008 include postulated responses to those Courses of Action 2011 by the terrorists and U.S./Allied/Indigenous stakeholder counter-responses. The ensuing states of affairs are generated at each point and the most desirable combination of Courses of Action 2011, including a prioritized List of Targets 6011 specified and sequenced for interdiction in each Course of Action 2011, forms the core of Campaign Plan 2012

Campaign Plan 2012 is next briefed to SCO 2002. The OCM 2004 is required to obtain the endorsement of Campaign Plan 2012 from the SCO 2002 before execution of the first Course of Action 2011 may begin. Courses of Action 2011 are executed in parallel (using multiple Mission Executions 2006) and serially as necessary. Once a Course of Action 2011 has been submitted to a Mission Commander 2007; all Mission Executions 2006 are planned by the Mission Commander 2007, approved by OCM 2004 and executed by Mission Commander 2007. After Action Reviews 2008 are conducted after each Mission Execution 2006.

OCM 2004 and Mission Commander 2007 jointly decide how far each mission has advanced the campaign toward one or more Operational Objectives 1017. If, OCM 2004 and Mission Commander 2007 determine that an Operational Objective 1017 has been achieved; they may produce a Course of Action Report 2016 and brief it to the SCO 2002. SCO 2002 will make a determination as to whether this latest accomplishment has created a situation where the terrorist conspiracy is irrevocably disrupted and a strategic objective 1007 has been achieved or if the OCM 2004 needs to submit an updated Campaign Plan 2012 and proceed with the next Course of Action 2011. This continues until the case is deactivated due to:
a lack of information and/or terrorist events for a significant period causing the SCO 2002 to rescind the endorsement for Campaign Plan 2012, or
SCO 2002 determines that the terrorist conspiracy is irrevocably disrupted.

Both Initial Hypothesis 3001 and Supported Hypothesis 3005 are influenced by a modified balance of power theory. Conventional balance of power theory, as would be familiar to those of skill in the art, concerns the behaviors of nation states in a global context. In embodiments according to the present invention, however, a new balance of power theory has been derived which explains and predicts the behavior of sub-national elements operating within Geographic Areas of Responsibility 1013. In the balance of power theory of embodiments according to the present invention, it is assumed that goals are achievable once the requisite amount and type of power is accrued. As the theory is applied herein, there are essentially four types of power:
Political Power—Explicit authority conferred by the populous
Military Power—strength and capacity for lethal force
Economic Power—wealth, the capacity to generate wealth and the liquidity of wealth
Institutional Power—the power to maintain the status quo. Institutional power is proportional to confidence, on the part of the populous, in the continued existence of institutions critical to their way of life. For example, an employer's ability to retain his employees is significantly reduced if the employees begin to doubt the viability of the company. Thus, an erosion of confidence in the continued existence of the institution equates to less institutional power by the company's leaders.

Embodiments of a CMCTS according to the present invention are based, at least in part, on the assumption that terrorists seek power to cause political change. In one aspect, power may be treated as a commodity that is readily exchanged between various actors in a terrorist conspiracy. For instance, a politician might engage the services of a group of thugs in a conspiracy to overthrow a competitor by offering protection against prosecution. This would be an obvious exchange of military and political power between the thugs and the politician. The economic principle of comparative advantage sets up a power trading system between the conspirators. Comparative advantage is also the reason that particular individuals and organizations are chosen or created for the conspiracy.

In a society, power is typically concentrated in ways that can be observed if one knows what to look for. Political institutions within a NAI 1011 hold significant amounts of political power. The military, police, state security, armed criminals and paramilitary organizations hold most of the military power. Large corporations, wealthy individuals and medium-size business concerns hold much of the economic power in any NAI 1011. Judicial entities are a special center of power because they serve to prevent the erosion of Institutional power held by those in power.

### Centers of Power

One aspect of an embodiment of a CMCTS according to the present invention involves identifying Centers of Power and evaluating interconnections between Centers of Power at sub-national levels. In most Geographic Areas of Responsibility 1013, the county level provides an effective focus of inquiry with county-level Centers of Power representing identifiable, locatable and track-able entities that include state and national level representation. Municipal centers of power may also be the subject of inquiry, analysis, and action, in appropriate cases.

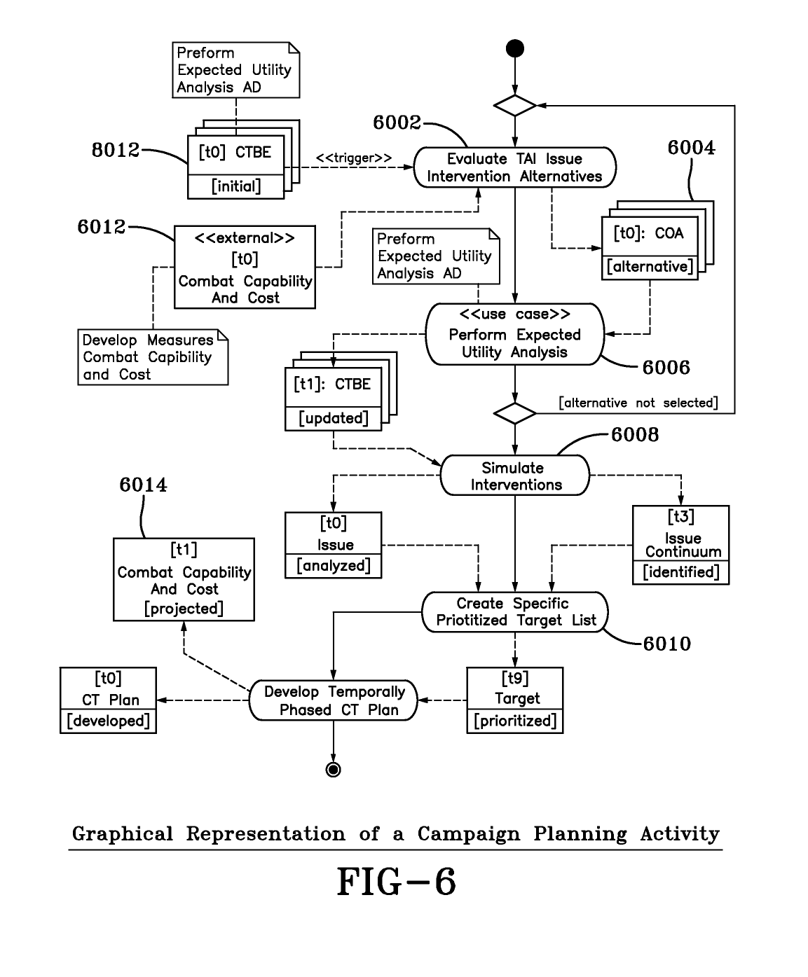

FIG. 6 shows several representative Centers of Power 5001, 5002, 5005, and 5008 such as might be found with initial intelligence in an Operational Case 1004 at a county level: a county police force 5002, a political party 5001, a branch of a national bank 5005, and a group of known terrorists 5008. A COP analysis is focused on a geopolitical entity within a Geographic Area of Responsibility 1013, such as a county. While the name for “county” differs from place to place (a “county” may be called a canton, prefecture, district, xiàn, parish, borough, or the like, depending on the region), the “county” is generally a recognizable and repeatable geopolitical entity worldwide.

In FIG. 5, Centers of Power 5001, 5002, 5005, and 5008 are shown in a state prior to intervention in which areas of influence are overlapping and there are interconnections between Centers of Power that could constitute a terrorist conspiracy. A number of individuals who are internally associated with Centers of Power 5001, 5002, 5005, and 5008 are also shown. In this initial state, some individuals are associated with or linked to multiple Centers of Power 5001, 5002, 5005, and 5008. Also shown is an external provocateur 5010. External provocateur 5010 is depicted as having connections to one or more of individuals, each of whom has a nexus to at least one COP 5001, 5002, 5005, and 5008.

In the simplified view shown in FIG. 5, Centers of Power 5001, 5002, 5005, and 5008 are shown as boxes having areas of overlap to illustrate the existence of and extent to which there are interactions, cooperation, and mutual dependency between and among Centers of Power 5001, 5002, 5005, and 5008. These areas of overlap represent potential target areas that must be evaluated to determine whether they should be considered Targeted Areas of Interest 5004. Significant interactions between Centers of Power 5001, 5002, 5005, and 5008 help to define Targeted Areas of Interest 5004. The identification of Target Areas 5004 permits intelligence resources to be focused and optimally deployed.

In one example, a Targeted Area of Interest 5004 may be revealed by determining that an individual operates across one or more Center of Power 5001, 5002, 5005, and 5008. A Targeted Area of Interest 5004 may also be identified by observing transactions between Centers of Power 5001, 5002, 5005, 5008, such as telephone calls, contracts, transfers of money, and the like. Arrows crossing boundaries between Centers of Power 5001, 5002, 5005, and 5008 in FIG. 5 represent transactions between Centers of Power. These transactions must be viewed as part of a power arbitrage system or their true relevance can easily be overlooked. For example, a transaction as mundane as money being deposited in a local bank branch by a police officer takes on a much more insidious appearance when one can see that the money originated with a person outside of NAI 1011 who is also providing tasking to a known terrorist who resides inside of the NAI 1011. In another example, the fact that a policeman is a party functionary with 2nd tier party associates should raise suspicion. In a Centers of Power Analysis; the political party (i.e., a significant political entity seeking power, which could be an individual or a group of individuals) is a critical focus. In embodiments concerning terrorism, it bears repeating that for violence to qualify as terrorism there must be a political element and politically motivated violence against non-combatants. Degrees of overlapping influence and interconnections may be evaluated by observing the frequency and the nature of transactions between “significant” groups or individuals in two or more Centers of Power 5001, 5002, 5005, and 5008. In general, the significance of a connection may be measured by an individual or a group's willingness to act to advance terrorism taking into consideration that person or group's resources with which to act. Targeted Areas of Interest 5004 are frequently derived from an iterative application of a centers-of-power analysis, described more particularly below.

While FIG. 5 shows several representative Centers of Power 5001, 5002, 5005, and 5008 a number of others may be identified in a Geographical Area of Interest. For example, Centers of Power may include: organized crime groups, state security organizations, municipal police, national, state, country and municipal court systems, religious groups, social organizations, educational institutions, commercial entities, trade organizations, charities, and the like. Center of Power links such as those shown in FIG. 5, are derived and evaluated by intelligence resources that are tasked to examine and detail the nature, frequency, importance, and substance of ongoing interactions among the various Centers of Power. As a Centers of Power analysis unfolds, a detailed picture of who depends on whom, as well as of their plans, methods and motives, emerges.

A Centers of Power view in embodiments according to the present invention is not static, and evolves as new intelligence is collected. In the initial stages, an overlap between Centers of Power may be tentative, or only weakly suggested by available information sources, but may be eliminated or detailed as new information is obtained. Graphical representations of such evolving Centers of Power views are preferably made available to the OCM 2004 and possibly the SCO 2002 on their respective user interfaces, via computer networks in a CMCTS network environment, such as illustrated in FIG. 7.

### Front End Assessment

As shown in FIG. 3, and the more detailed view of the flow diagram of FIG. 3 as shown FIGS. 3A, 3B and 3C, a Front End Assessment 3000 is performed by OCM 2004 based on an Initial Hypothesis 3001 provided by SCO 2002. Front End Assessment 3000 leads to an Intelligence Assessment 3004 that forms the basis for the Develop CT Plan activity 2005. Front End Assessment 3000 may be performed once or may be an iterative process that repeats until incongruities between intelligence products and the hypothesis 3005 are resolved. SCO 2002, OCM 2004 and their domain experts 7012 begin this activity by processing relevant intelligence to develop an Initial (or partial) Hypothesis 3001 about the Interest 3007, Strategy 3008 and Goals 3010, and Desired End State 3010 of a Threat. Initial Hypothesis 3001 will usually be provided by SCO 2002, and augmented by OCM 2004.

Front End Assessment 3000 relies upon Expected Utility Analysis 3006. For background on expected utility analysis, see, “Bernoulli, D (1954), Exposition of a New Theory on the Measurement of Risk, (original: 1738), Econometrica, 22:23-36; Schoemaker P J H (1982) “The Expected Utility Model: Its Variants, Purposes, Evidence and Limitations”, “Journal of Economic Literature”, 20:529-563.

Expected Utility Analysis takes into account stakeholder resources, risk aversion, preference rankings from a set of foreseeable outcomes and stakeholder estimates of the probability of occurrence for each outcome. For a given state of affairs and a finite set of possible outcomes, Expected Utility Analysis 3006 produces a prediction as to the level of support each stakeholder will provide for each possible outcome. Predicted stakeholder actions and payoffs are developed on the basis of the four power types, i.e., Political, Military, Economic and Institutional, as noted above. The output of Expected Utility Analysis 3006 is an issue description, a priori conditions, recommended intervention, composition changes in various coalitions and stakeholders' likely position changes resulting from each intervention. This also includes a post priori “issue position” (i.e., a predicted outcome) that is incorporated into a document called the Counter-Terrorism Basic Encyclopedia 8012. This analysis is conducted initially as part of the Front End Assessment 3000, and is re-iterated as Missions 2006 are executed, resulting in a new situation. Such an analysis provides a time-tested basis for shaping, predicting and responding to an adversary's decision-making in reaction to each planned mission execution.

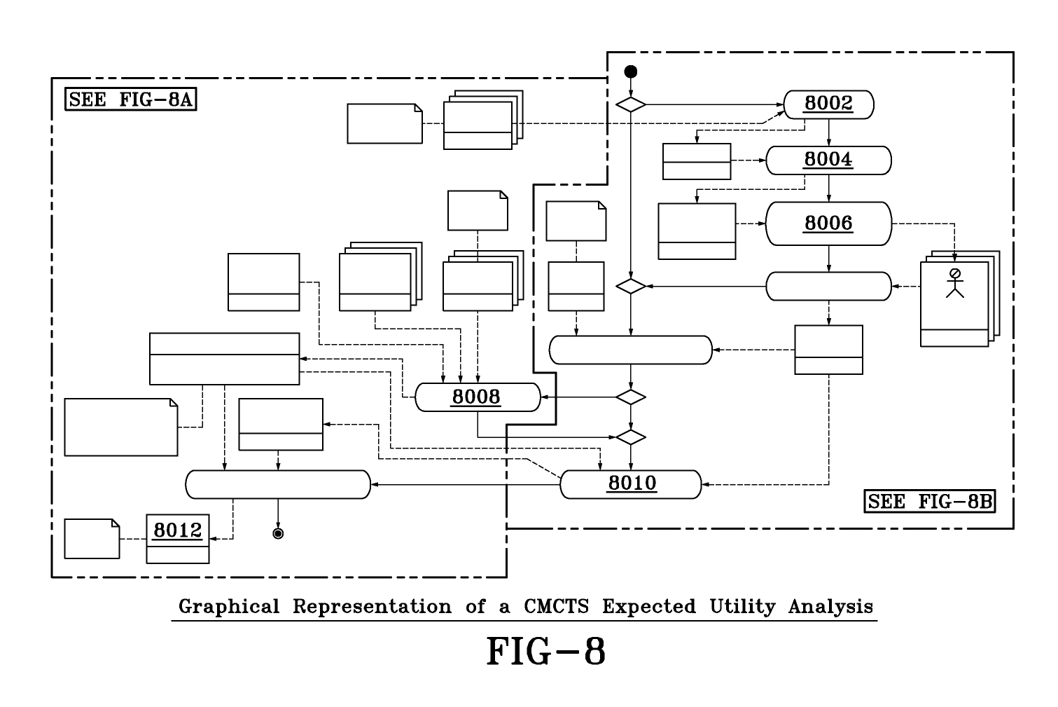

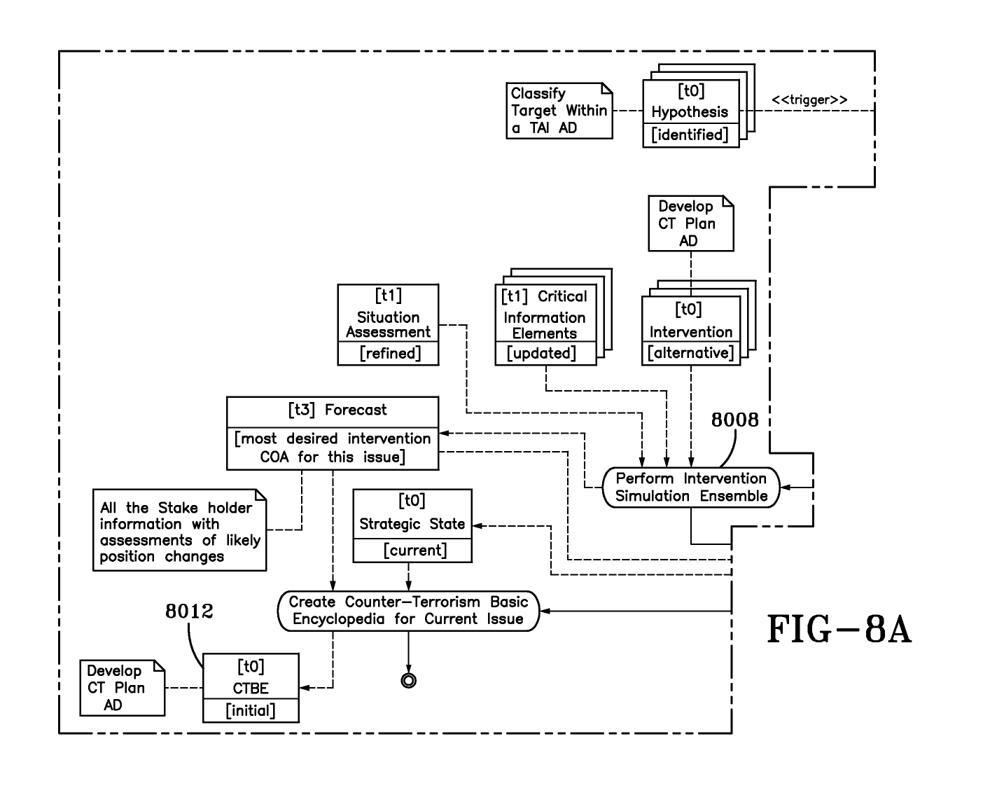

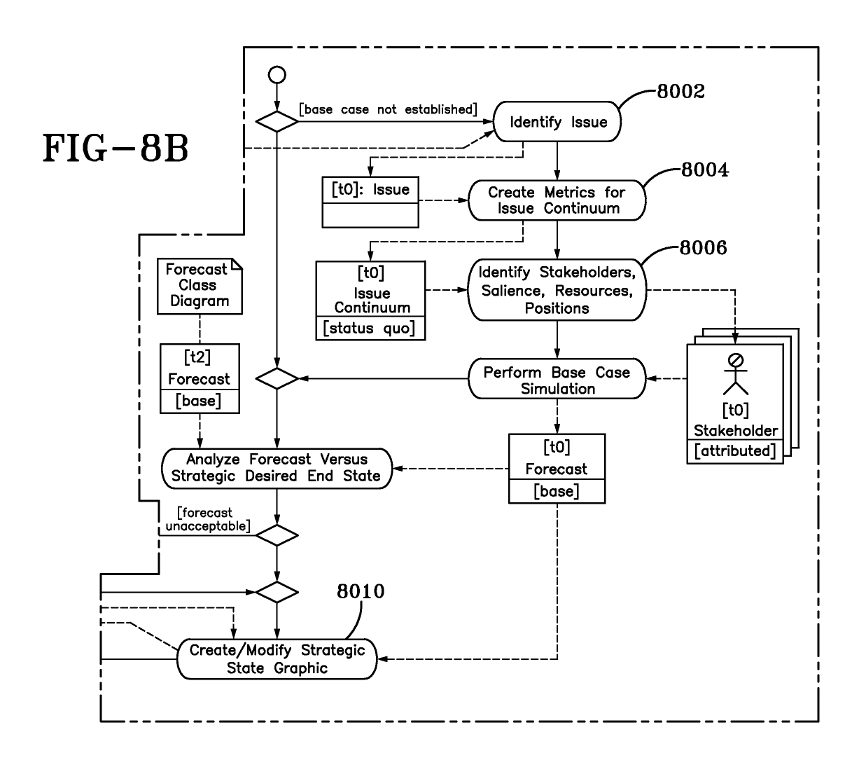

FIG. 8, and the expanded view of FIG. 8 shown in FIGS. 8A and 8B, show an Expected Utility Analysis Activity Process in an embodiment according to the present invention. Using the initial information and hypothesis; the Identify Issues activity 8002 produces a set of issues to be analyzed. Such issues may be the loss of a key individual, the loss of a specific financial services, increase of an external military presence, or any other matter the stakeholders would have an interest in. Metrics are devised in the Create Metrics for Issue Continuum 8004 using assessments of:
The amount and types of power possessed/sought by each stakeholder,
The material resources possessed by each stakeholder,
The likelihood that each stakeholder will act in order to protect his position in the face of various types of challenges
The position on each issue taken by each stakeholder
   This information is obtained from intelligence information collected in support of the Identify Stakeholders, Salience, Resources, Positions activity 8006 to front-load the modeling tools, employed iteratively in 8008. These models produce information about stakeholders' willingness to act and their positions with respect to each issue. This information may be displayed by an appropriate graphic tool 8010, and is stored as part of Counter-Terrorism Basic Encyclopedia 8012.

Using Initial Hypothesis 3001 and intelligence contained in a Situation Assessment 3011 concerning the various stakeholders involved, the known transactions between those actors and institutions are investigated along with the resources available to the actors. This front-loads the process of Expected Utility Analysis 8000 (in 3006 of Front End Assessment 3000) with an identification of a range of expected actions by the stakeholders. In the course of analyzing the transactions between stakeholders, the CMCTS augments a conventional link analysis by superimposing the link analysis onto a set of relevant Centers of Power to arrive at an augmented Link Analysis 3012. This approach results in the modified Venn Diagram representation of FIG. 5 which is meaningful for planning disruption of terrorist activities and which results in a Systemic View 3013 of activities of adversaries.

Front End Assessment 3000 concludes with the identification and exploration of Targeted Areas of Interest 5004 found in the interactions between Centers of Power, supported by the results of augmented Link Analysis 3012. This information is used to develop a true Systemic View 3013 of the Centers of Power and their transactions. A Vulnerability Assessment 3014 and relative prioritization of Targeted Areas of Interest 5004 is then conducted to support the creation 3015 of the initial briefing for the SCO 2002 and the Prioritized Intelligence Request 9001. Vulnerability Assessment Activity 3014 takes into account legal vulnerability as well as traditional military vulnerability. This process generates Prioritized Intelligence Request 9001, for efficient, expedient Intelligence Collection Activities 9000. The target of this focused collection is usually an asset, individual or organization within a Targeted Area of Interest 5004. The CMCTS analytical approach is naturally very efficient in this regard since it does not attempt to “cast a broad net.” Rather, CMCTS analysts preferably use generic, open source, and widely available intelligence sources to tightly focus the areas of inquiry before focused collection ever becomes necessary. The prioritized list of Targeted Areas of Interest 5004, serves as a Target Folder 3003, which, augmented by the systemic view of adversary's activities developed in Front End Assessment 3000, serves as a starting point for Campaign Planning activity 2005.

### Campaign Plan

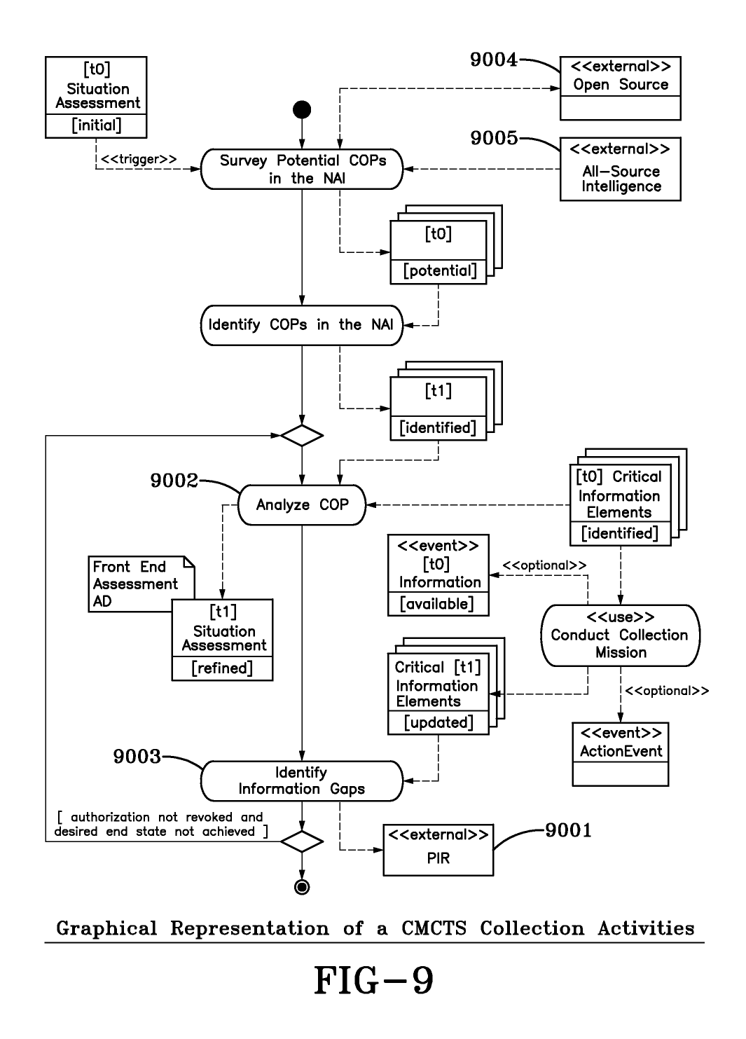

After Front End Assessment 3000 is performed, a Campaign Plan 2012 is developed. Campaign Plan 2012 identifies and outlines Operational Objectives 1017 and time-phased interventions, and is approved at the strategic level. During Campaign Planning 2005, OCM 2004 will begin collecting all available Open Source Intelligence 9004 as well as any classified briefings related in any way to the NAI 1011 in an Intelligence Collection Activity 9000, represented in FIG. 9. Intelligence Collection Activity 9000 will continue, uninterrupted in the background as long as Operational Case 1004 is open.

By pursuing terrorism according to Campaign Plan 2012 derived from a Center of Powers Analysis 5000, counterterrorism resources may be allocated to maximize their effect on populations that are, or soon may be, victimized by terrorism, rather than simply taking remedial action to destroy bad actors and their resources after they have taken root in a region.

In particular, Counter-terrorism operations are selected and carried out based on an assessment as to which actions would most likely dissuade cooperation among and between Centers of Power 5000 such as Centers of Power 5001, 5002, 5005 and 5008. At the point when overlap among or between Centers of Power 5000 is sufficiently reduced, terrorism becomes a matter for effective criminal law enforcement under the laws of the host nation, possibly with support assistance from the U.S. and Coalition nations allied against terrorism.

An aggregated view of the level of inter-connectedness between Centers of Power 5000 provides initial conditions for Operational Case 1004. It is the goal of every Operational Case 1004 to reduce the kind of connectedness among Centers of Power 5000 that facilitates terrorist activities. In short, the nexus of corruptible government, organized crime influences, terrorist groups, etc. in the particular area of interest are targeted for disruption to the point where overlaps are minimized.

### Campaign Planning

FIG. 6 shows a flow diagram of a Campaign Planning Activity 6000. Interpretation of a Centers of Power Analysis 5000 produces a systemic understanding of a terrorist conspiracy. Issue Intervention Alternatives 6002 for Targeted Areas of Interest 5004 are developed and a series of “what if” Expected Utility Simulations 6006 are run to find out which Targeted Areas of Interest 5004 are critical enablers of the conspiracy and how the conspiracy might react if some or all Targeted Areas of Interest were disrupted by the various Intervention Alternatives 6002. Targeted Areas of Interest 5004 may be categorized by their importance to the counterterrorism plan. A critical and difficult-to-replace Targeted Area of Interest 5004 may be identified as a High Payoff Target. A less critical Targeted Area of Interest 5004 that lends itself to a low-cost disruption with significant impact to the conspiracy may be identified as a High Value Target. Any important stakeholder in the conspiracy (one with high resources or salience), regardless of how replaceable he is, may be classified as a Target.

With the systemic understanding of the adversary developed in Front End Assessment 3000, the several proposed Intervention Alternatives 6002 are postulated and assessed for manageability, cost-effectiveness, timeliness and minimization of undesired effects. For purposes of this invention disclosure, a “target” includes assets, individuals or organizations within a Targeted Area of Interest 5004. Tactical interventions are assessed according to target criticality to the adversary's system of power exchange and likely reactions to various methods of rendering each target. Here, the availability of non-traditional tactical assets presents entirely new options for rendering targets. For instance, the effect of Coalition troops killing a terrorist are different than if the same troops were to arrest a targeted individual and a lengthy detainment were imposed through legal process. The difference is even more pronounced if indigenous law enforcement authorities arrests and confines the same target. One important aspect of an embodiment of a CMCTS according to the invention is the ability to disrupt the power exchanges that adversaries rely upon based on an indirect action. For example, a Centers of Power 5000 Analysis may uncover criminal activity unrelated to terrorism. Effective disruption of terrorist activities in a Named Area of Interest 1011 may be accomplished in many instances by prosecuting key individuals for such criminal activities (e.g., tax evasion, money laundering, fraud, etc).

An initial Campaign Plan 2012 is determined by propagating states expected to result from Intervention Alternatives 6002. These states are propagated using an expected utility model until all paths leading to a desirable end-state are identified and can be evaluated in such a way that the path which minimizes the cost while maximizing the effective destruction of the adversary's power base can be identified and adopted as the initial Campaign Plan 2012. This minimization of cost, with maximization of desired effect is merely an adaptation of the Von Neumann/Morgenstern Minimax algorithm.

### Cost of Capability

An aspect of the present invention is the inclusion of cost-modeling at each phase of planning from campaign planning through tactical planning to ensure the most effective use of resources and maximum desirable result. The CMCTS is amenable to use with various service- or agency-specific cost models and tools. This Cost-of-Capability Assessment 6012, occurring in parallel with Simulation of Interventions 6008, is essential for both immediate application of available resources in a Campaign Plan 2012 and as feedback for longer-term acquisition cycles. Cost-of-Capability assessment 6012 may include equipment costs (mission & support) personnel costs and, logistics costs. A cost of Capability Assessment 6014 may be performed for each intervention under consideration in Mission-level Simulations 6008. Utilization costs may also be integrated with Mission-level simulations 6008, such that a relative Cost-of-Capability projection 6014 may be included with the Campaign Plan 2012.

Campaign planning incorporates the use of Mission-level Simulations 6008 to further explore the various tactical options and interventions available. Mission-level Simulations 6008 may be as simple as evaluations of the placement of limited signal collection assets for the highest probability of intercept of a target emitter, or as complex as the assessment of the most effective combination of manned, unmanned, ground and air surveillance assets to cover all the likely (i.e., expected utility analysis derived) actions an adversary may take in response to a planned Intervention Alternative 6002. Additionally, Intervention Alternatives 6002 contemplated for every scenario should also have cost and utility metrics assigned to them (see Table 1).

TABLE 1
Metrics assigned to every contemplated tactical action

| Cost Metrics | Effectiveness Metrics (Utility) |
|---|---|
| Loss, in strategic goal | Amount of gain toward strategic goal |
| terms, due to undesirable effects | achievement that the move is |
| | expected to yield if successful |
| Loss in strategic goal terms due to | Amount of gain toward Operational |
| failure to execute the move | Objective achievement that the move |
| successfully | is expected to yield if successful |
| Actual cost in terms of expended | |
| resources, logistics and operations | |

The CMCTS Campaign Planning Activity prioritizes targets of Missions 2006 in terms of the expected disruption of the adversary's systems of power exchange. The system of effectiveness metrics enables the assessment of each Course of Action 2011 in terms of ultimate strategic objectives. Prioritization of targets in this broad context ensures efficiency.

Once the initial Campaign Plan 2012 is complete; it is briefed to the SCO 2002. Upon endorsement; the campaign is resourced and the first Course of Action 2011 is carried out. After the necessary “settling time,” the state of affairs is assessed and the campaign planning process (minimax algorithm) is re-executed so that all effects including exogenous events (outside the scope or control of Campaign Plan 2012) are constantly factored in.

### Relevant Information Updates

The CMCTS relies upon the continuous use of commonly available Open Source Intelligence 9004 and methods. This continuous reliance is illustrated (in FIG. 9) as the Centers of Power analysis 9002 iterates and Information Gaps 9003 are identified. Focused collection (which produces Intelligence Information 9005, in response to a Prioritized Intelligence Request 9001) is only used when an Information Gap 9003 cannot be filled in any other way. This approach reduces cost and risk. Open Source Intelligence 9004 includes local, national and international media, including, but not limited to, news reporting, public and private databases, market forecasts, government reports, etc., which are monitored 8006 in expected utility analysis 8000 to continually reevaluate a stake holder's salience, resources, or position on any relevant issue identified 8002. These information updates, ensure rapid adaptation of the Campaign Plan 2012 to changing circumstances.

### Example Implementation

FIG. 7 shows an exemplary implementation of a CMCTS architecture 7000 according to an embodiment of the present invention. The system is built around a Central Fusion Server 7006 allowing convenient access to multiple, External Databases 7004 and information resources. Central Fusion Server 7006 provides case management control and User Interfaces (“Dashboards”) 7002 for Strategic, Operational and Tactical users and their support, as well as all CMCTS-unique displays and tools. Central Fusion Server 7006 operates asynchronously drawing on resources from diverse geographical locations. A wide variety of wired and wireless systems may be used to link system components. For example, this embodiment is implemented in Java2 Platform Enterprise Edition (J2EE) and Extensible Markup Language (XML). J2EE is platform independent and portable and exploits dominant emerging architecture paradigms (e.g., service-oriented, component-based, event-driven) to enable a number of disparate applications to interact, seamlessly, as a composite application. This capability allows many separately maintained External Databases 7004 and resources (such as wire services, stock tickers, etc.) to be used transparently and without alteration. This reduces data maintenance costs. While J2EE and XML are preferred at present, other products/environments may better fulfill this requirements for the CMCTS in future embodiments.

The embodiment of FIG. 7 also relies upon Uniform Modeling Language (UML) Descriptions 7003 of the overall CMCTS Ontology 1000 and the Counter-Terrorism Case Management Domain 1005. The Classes, Activities and States of Case Management Domain 1005 are realized in the workflow-based access controls of the Central Fusion Server 7006. This server supports smart client applications that present and control the Strategic, Operational and Tactical User Interfaces 7002 and data views. This embodiment supports all activities required by the CMCTS, including UML Modeling 7008, Expected Utility Analysis, Centers of Power Analysis 7005 and Mission Level modeling 7007. Support specialties employed by a CMCTS may include UML Modelers 7013, EU Modelers 7009, and PEMI Assessors 7010. Various Domain Experts 7012, such as legal advisors, drug interdiction experts, weapons trafficking consultants, etc., may also be tasked to directly support users of one or more embodiments hereunder.

### CONCLUSION

The present invention describes a CMCTS that enables a systematic, effects-based approach to fighting and winning the Global War on Terror. A number of embodiments of the invention defined by the following claims are possible. Nevertheless, it will be understood that various modifications to the described embodiments may be made without departing from the spirit and scope of the claimed invention. Embodiments according to the present invention may be implemented using hardware, software or a combination thereof and may be implemented in one or more computer systems or other processing systems capable of carrying out the functionality described herein. The system may be configured as a distributed system that exchanges data and instructions over local and/or wide area networks allowing multiple user access at multiple ports. While embodiments according to the present invention have been described in terms of a United States lead coalition, alternative embodiments may apply to counterterrorism efforts directed by other states, groups of states or geopolitical entities. Accordingly, other embodiments are within the scope of the invention, which is limited only by the following claims.

1-12. (canceled)

13. A computer program product embodied in a computer-readable medium, that provides a case managed counter terrorism system, comprising:
software instructions for enabling the computer to perform predetermined operations, and
a machine-readable medium bearing the software instructions;
the predetermined operations including:
developing a hierarchy of metrics at tactical, operational and strategic levels to determine the degree of success achieved at each level;
determining centers of power for a named area of interest where a terrorist conspiracy exists;
gathering open source information and intelligence to identify transactions between a plurality of centers of power in the named area of interest;
determining targeted areas of interest from the identified transactions between the plurality of centers of power in the named area of interest;
collecting information within each targeted area of interest to develop a systematic understanding of the terrorist conspiracy;
creating a campaign plan to identify one or more optimum courses of action to disrupt the terrorist conspiracy;
executing the campaign plan based on a front end assessment of the likely reaction of the terrorist conspiracy to the one or more courses of action; and
reassessing and revising the campaign plan, as necessary, during execution until the tactical, operational and strategic metrics have achieved the predetermined levels of success.

14. The computer program product according to claim 13 wherein reassessing and revising the campaign plan comprises utilizing mission level simulations integrated with detailed cost models to determine maximum effect with acceptable cost.

15. The computer program product according to claim 13 wherein reassessing and revising the campaign plan comprises performing an expected utility analysis.

16. The computer program product according to claim 13 wherein creating a campaign plan to identify one or more optimum courses of action to disrupt the terrorist conspiracy comprises determining a course of action that has the least cost, highest payoff and lowest profile.

17-29. (canceled)

30. A computer program product embodied in a computer-readable medium, that provides a case managed system, comprising:
software instructions for enabling the computer to perform predetermined operations, and
a machine-readable medium bearing the software instructions;
the predetermined operations including:
developing a hierarchy of metrics at tactical, operational and strategic levels to determine the degree of success achieved at each level;
determining centers of power for a named area of interest where a conspiracy exists;
gathering open source information and intelligence to identify transactions between a plurality of centers of power in the named area of interest;
determining targeted areas of interest from the identified transactions between the plurality of centers of power in the named area of interest;
collecting information within each targeted area of interest to develop a systematic understanding of the conspiracy;
creating a campaign plan to identify one or more optimum courses of action to disrupt the terrorist conspiracy;
executing the campaign plan based on a front end assessment of the likely reaction of the terrorist conspiracy to the one or more courses of action; and
reassessing and revising the campaign plan, as necessary, during execution until the tactical, operational and strategic metrics have achieved the predetermined levels of success.

31. The computer program product according to claim 30 wherein reassessing and revising the campaign plan comprises utilizing mission level simulations integrated with detailed cost models to determine maximum effect with acceptable cost.

32. The computer program product according to claim 30 wherein reassessing and revising the campaign plan comprises performing an expected utility analysis.

33. The computer program product according to claim 30 wherein creating a campaign plan to identify one or more optimum courses of action to disrupt the conspiracy comprises determining a course of action that has the least cost, highest payoff and lowest profile.
